(19) United States
(12) Patent Application Publication
(10) Pub. No.: US 2015/0121235 A1
(43) Pub. Date: Apr. 30, 2015

(54) ELECTRONIC DEVICE AND METHOD FOR MANAGING SERVERS

(71) Applicant: HON HAI PRECISION INDUSTRY CO., LTD., New Taipei (TW)

(72) Inventor: YEN-WEN CHEN, New Taipei (TW)

(73) Assignee: HON HAI PRECISION INDUSTRY CO., LTD., New Taipei (TW)

(21) Appl. No.: 14/135,607

(22) Filed: Dec. 20, 2013

(30) Foreign Application Priority Data
Oct. 31, 2013 (TW) 102139435

(51) Int. Cl. H04L 12/24; G06F 3/0484

(52) U.S. Cl. CPC H04L 41/22; G06F 3/04842
USPC 715/736

(57) ABSTRACT

In a method for managing servers, operation parameters of servers located in a room are downloaded from a database in response to receiving a quick response code (Qrcode) of a doorplate of the room. An electronic map is displayed on a display screen of the electronic device, the electronic map showing a location of the room and a location of each of the servers in the room. The operation parameters of the selected server are displayed in response to receiving a selected server on the electronic map.

### BACKGROUND

1. Technical Field

The embodiments of the present disclosure relate to an electronic device and method for managing servers.

2. Description of related art

A remote computer is usually used to manage servers through a remote surveillance network between the remote computer and the servers. Server managers uses the remote computer to obtain parameters of the servers such as voltage, temperature, or fan speed of the servers from baseboard management controllers (BMCs) of the servers. However, if, for example, the remote computer is powered off or the remote surveillance network is off-line, the remote management of the servers may be troublesome.

### BRIEF DESCRIPTION OF THE DRAWINGS

FIG. 1 is a block diagram of one embodiment of an electronic device including a server management system.

FIG. 2 is a block diagram of one embodiment of function modules of the server management system in FIG. 1.

FIG. 3 is a flowchart of one embodiment of a method for managing servers.

FIG. 4 is a diagram of one embodiment of a map showing locations of a room and the servers in the room.

FIG. 5 is a diagram of one embodiment of a searching area for searching the servers of which parameters are qualified for a searching qualification.

FIG. 6 is a diagram of one embodiment for marking the searched servers.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, flash memory, and hard disk drives.

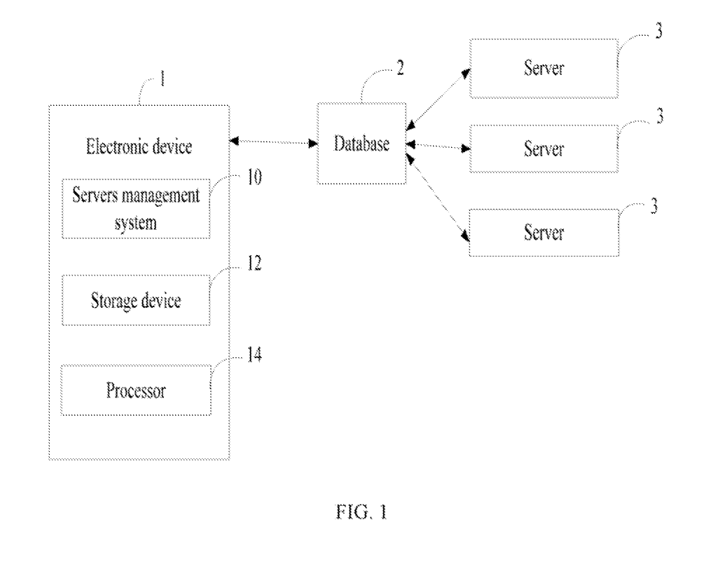

FIG. 1 is a block diagram of one embodiment of an electronic device 1 including a server management system 10. In the embodiment, the electronic device 1 may further include a storage device 12, and at least one processor 14. The electronic device 1 may be a desk computer, a notebook, or a cellular phone and so on. The electronic device 1 connects to a database 2 through a wireless network.

The database 2 stores operation parameters of a plurality of servers 3 located in several rooms. The operation parameters of each server 3 can be read by a baseboard management controllers (BMC) (as shown in FIG. 1) of the server 3, and can updated in the database 2 in a real-time. In the embodiment, the operation parameters stored in the database 2 may be a fan speed, a processor temperature, a processor usage rate, or other performance parameters of each of the servers 3.

The servers 3 are located in several rooms, and each of the rooms is assigned with a quick response code (Qrcode) on its doorplate. Once the Qrcode of the room is scanned, the operation parameter of the servers 3 in the room is downloaded to the electronic device 1 from the database 2.

In one embodiment, the storage device 12 (a non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

In one embodiment, the server management system 10 includes a plurality of function modules which include computerized codes or instructions that can be stored in the storage device 12 and executed by the at least one processor 14 to provide a method for managing the servers 3.

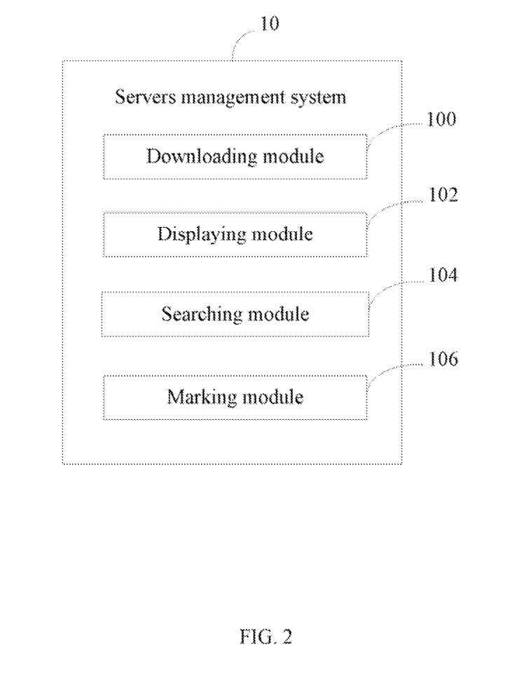

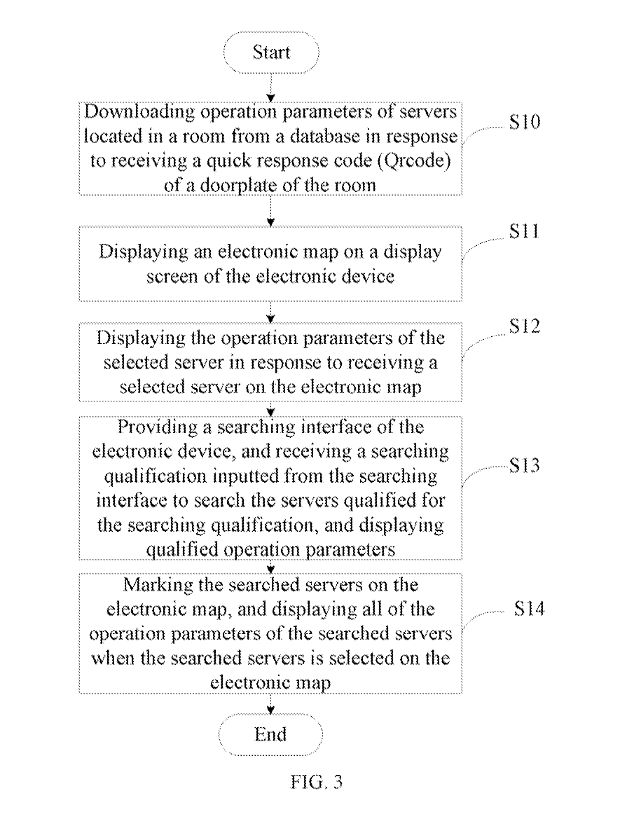

FIG. 2 is a block diagram of one embodiment of function modules of the server management system 10 in FIG. 1. In the embodiment, the server management system 10 includes a downloading module 100, a displaying module 102, a searching module 104, and a marking module 106. The modules may comprise computerized codes in the form of one or more programs that are stored in the storage device 12 and executed by the at least one processor 14 to provide functions for implementing the server management system 10. The functions of the function modules are illustrated in FIG. 3 and described below.

FIG. 3 is a flowchart illustrating one embodiment of a method for managing the servers 3. Depending on the embodiment, additional steps may be added, others removed, and the ordering of the steps may be changed.

In step S10, the downloading module 100 downloads the operation parameters of the servers 3 located in the room from the database 2 in response to receiving a quick response code (Qrcode) of the doorplate of the room.

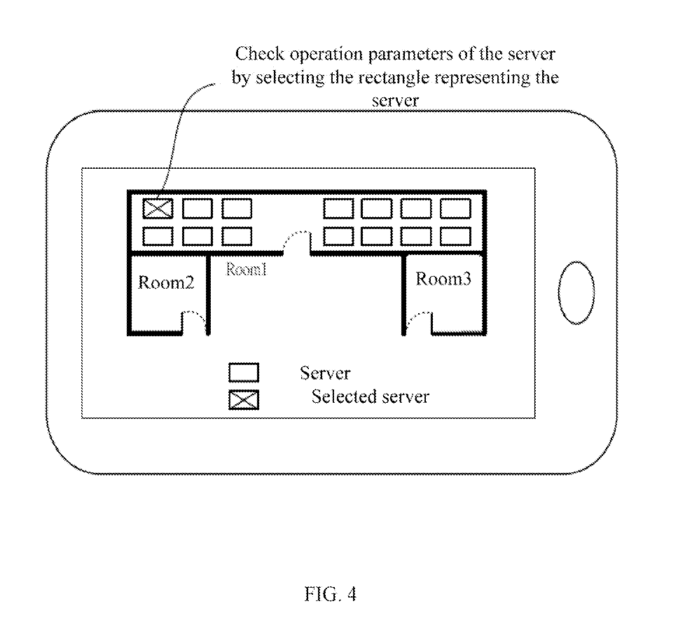

In step S11, the displaying module 102 displays an electronic map on a display screen of the electronic device 1, the electronic map showing a location of the room and a location of each of the servers 3 in the room. As shown in the FIG. 4, the displaying module 102 displays the electronic map showing the location of the room 1 and the location of each of the servers 3 in the room on the electronic device 1. In the embodiment, each of the servers 3 may be marked in the electronic map by a small rectangle or other shape marks.

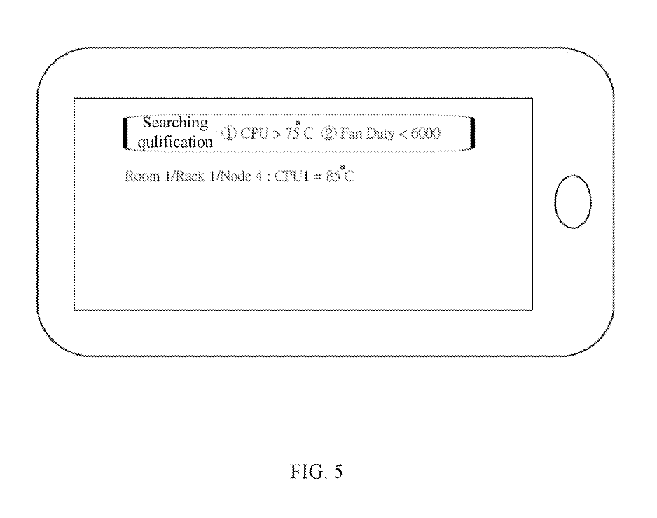

In step S12, the displaying module 102 displays the operation parameters of the selected server 3 in response to receiving a selected server 3 on the electronic map. As shown in the FIG. 5, the operation parameters of the server 3 is displayed on the display screen of the electronic device 1 when the small rectangle representing the server 3 is selected.

In step S13, the searching module 104 provides a searching interface of the electronic device 1, and receives a searching qualification inputted from the searching interface to search the servers 3 qualified for the searching qualification, and displays qualified operation parameters of the searched servers 3 on the display screen the electronic device 1. As shown in the FIG. 5, the searching qualification may be CPU>75° C., Fan<6000 duties, the searching module 104 searches the servers of which the operation parameters are qualified for the searching qualification, and displays the qualified parameters of the searched servers on the electronic device 1.

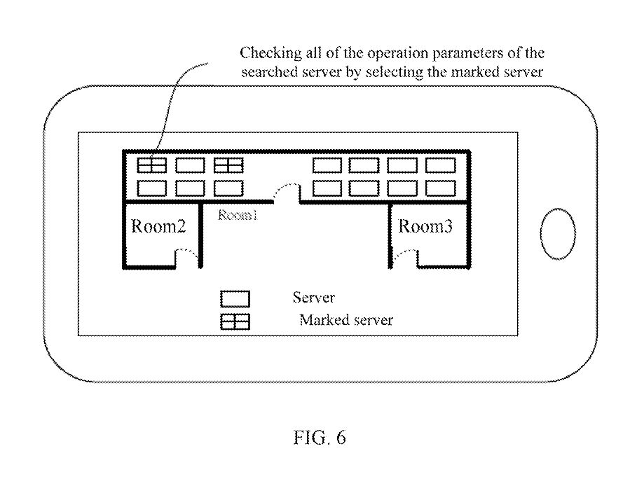

In step S14, the marking module 106 marks the searched servers 3 on the electronic map, and displays all of the operation parameters of the searched servers 3 when the searched servers 3 is selected on the electronic map. As shown in the FIG. 6, the searched server 3 may be marked as a rectangle including a cross tag.

Although certain disclosed embodiments of the present disclosure have been specifically described, the present disclosure is not to be construed as being limited thereto.

Various changes or modifications may be made to the present disclosure without departing from the scope and spirit of the present disclosure.

What is claimed is:

1. An electronic device, comprising:
at least one processor; and
a storage device storing a computer program including instructions that, which executed by the at least one processor, causes the at least one processor to:
download operation parameters of servers located in a room from a database in response to receiving a quick response code (Qrcode) of a doorplate of the room;
display an electronic map on a display screen of the electronic device, the electronic map showing a location of the room and a location of each of the servers in the room; and
display the operation parameters of the selected server in response to receiving a selected server on the electronic map.

2. The electronic device as claimed in claim 1, wherein the computer program further causes the at least one processor to:
provide a searching interface of the electronic device, and receive a searching qualification inputted from the searching interface to search the servers qualified for the searching qualification, and display qualified operation parameters of the searched servers on the display screen the electronic device.

3. The electronic device as claimed in claim 2, wherein the computer program further causes the at least one processor to:
mark the searched server on the electronic map, and display all of the operation parameters of the searched server when the searched server is selected on the electronic map.

4. The electronic device as claimed in claim 1, wherein the operation parameters include a fan speed, a processor temperature and a processor usage rate of each of the servers.

5. The electronic device as claimed in claim 1, wherein the operation parameters are read by a baseboard management controllers (BMC) of each of the servers, and are updated in the database in a real time.

6. A method executed by a processor of an electronic device for managing servers, the method comprising:
downloading operation parameters of servers located in a room from a database in response to receiving a quick response code (Qrcode) of a doorplate of the room;
displaying an electronic map on a display screen of the electronic device, the electronic map showing a location of the room and a location of each of the servers in the room; and
displaying the operation parameters of the selected server in response to receiving a selected server on the electronic map.

7. The method as claimed in claim 6, further comprising:
providing a searching interface of the electronic device, and receiving a searching qualification inputted from the searching interface to search the servers qualified for the searching qualification, and displaying qualified operation parameters of the searched servers on the display screen the electronic device.

8. The method as claimed in claim 7, further comprising:
marking the searched server on the electronic map, and displaying all of the operation parameters of the searched server when the searched server is selected on the electronic map.

9. The method as claimed in claim 6, wherein the operation parameters include a fan speed, a processor temperature and a processor usage rate of each of the servers.

10. The method as claimed in claim 6, wherein the operation parameters are read by a baseboard management controllers (BMC) of each of the servers, and are updated in the database in a real time.

11. A non-transitory computer-readable storage medium having stored thereon instructions being executed by a processor of an electronic device, causes the processor to perform a method for managing servers, the method comprising:
downloading operation parameters of servers located in a room from a database in response to receiving a quick response code (Qrcode) of a doorplate of the room;
displaying an electronic map on a display screen of the electronic device, the electronic map showing a location of the room and a location of each of the servers in the room; and
displaying the operation parameters of the selected server in response to receiving a selected server on the electronic map.

12. The storage medium as claimed in claim 11, wherein the method further comprising:
providing a searching interface of the electronic device, and receiving a searching qualification inputted from the searching interface to search the servers qualified for the searching qualification, and displaying qualified operation parameters of the searched servers on the display screen the electronic device.

13. The storage medium as claimed in claim 12, wherein the method further comprising:
marking the searched server on the electronic map, and displaying all of the operation parameters of the searched server when the searched server is selected on the electronic map.

14. The storage medium as claimed in claim 11, wherein the operation parameters include a fan speed, a processor temperature and a processor usage rate of each of the servers.

15. The storage medium as claimed in claim 11, wherein the operation parameters are read by a baseboard management controllers (BMC) of each of the servers, and are updated in the database in a real time.
